(19) United States
(12) Patent Application Publication
(10) Pub. No.: US 2006/0233178 A1
(43) Pub. Date: Oct. 19, 2006

(54) Method and system for power efficient transmission of scalable video over wireless networks

(75) Inventors: Xiaoan Lu, Brooklyn, NY (US); Yingwei Chen, Briarcliff Manor, NY (US); Yao Wang, Matawan, NJ (US)

Correspondence Address: PHILIPS INTELLECTUAL PROPERTY & STANDARDS, P.O. BOX 3001, BRIARCLIFF MANOR, NY, 10510, US

(73) Assignee: Koninkljke Philips Electronics N.V. c/o Waxler, Aaron, Briarcliff Manor, NY (US)

(21) Appl. No.: 10/546,386

(22) PCT Filed: Feb. 13, 2004
(86) PCT No.: PCT/IB04/00417

§ 371 Date: Aug. 18, 2005

Related U.S. Application Data
(60) Provisional application No. 60/449,028, filed on Feb. 21, 2003.
(60) Provisional application No. 60/482,658, filed on Jun. 26, 2003.

(51) Int. Cl. H04L 12/56; H04J 3/16

(52) U.S. Cl. 370/395.21; 370/469

(57) ABSTRACT

A method and system for reducing power consumption in a wireless network by adjusting the transmit energy for each bit at the physical layer and the retry limit at the MAC layer. The method includes creating a look-up table containing optimal pairs of Nₗᵢₘ,Eₜ for a plurality of different sets of transmission properties, wherein Nₗᵢₘ is a retry limit and Eₜ is a transmit energy per bit; determing a set of transmission properties for a sequence of scalable video to be transmitted over the wireless network; accessing the look-up table to obtain the optimal pair of Nₗᵢₘ,Eₜ, corresponding to the set of determined transmission properties; and transmitting the sequence of scalable video over the wireless network using the accessed optimal pair of Nₗᵢₘ,Eₜ.

The present invention relates in general to wireless networks, and more particularly, to a method and system for power efficient transmission of scalable video over wireless networks (e.g., in a wireless network including portable multimedia devices).

Because of the high throughput provided by wireless local area networks (WLAN), real-time video communication over a WLAN is becoming feasible.

The possible applications include video communications on portable devices, portable video servers, etc. These types of WLAN devices often rely on batteries for operation. Batteries have limited life time and frequent recharging is not desirable. With the integration of video transmission, which requires high bandwidth and high power for transmission, power management becomes even more important.

The present invention considers the situation where scalable video data is transmitted over a WLAN, in which retransmission is adopted as the error control scheme. One goal of the present invention is to keep a constant video quality at the receiver while minimizing the overall transmission power, or conversely, to optimize video quality given a fixed transmission power resource.

In the present invention, to minimize the transmission power while keeping a constant video quality at the receiver, the transmission energy at the physical layer and the retransmission scheme at the medium access control (MAC) layer are considered. In particular, the present invention reduces power consumption by adjusting the transmit energy for each bit at the physical layer and the retry limit at the MAC layer.

In general, the present invention provides a method for power efficient transmission of scalable video over a wireless network, comprising: creating a look-up table containing optimal pairs of Nₗᵢₘ,Eₜ for a plurality of different sets of transmission properties, wherein Nₗᵢₘ is a retry limit and Eₜ is a transmit energy per bit; determining a set of transmission properties for a sequence of scalable video to be transmitted over the wireless network; accessing the look-up table to obtain the optimal pair of Nₗᵢₘ,Eₜ corresponding to the set of determined transmission properties; and transmitting the sequence of scalable video over the wireless network using the accessed optimal pair of Nₗᵢₘ,Eₜ.

The present invention also provides a system for power efficient transmission of scalable video over a wireless network, comprising: a look-up table containing optimal pairs of Nₗᵢₘ,Eₜ for a plurality of different sets of transmission properties, wherein Nₗᵢₘ is a retry limit and Eₜ is a transmit energy per bit; a system for determining a set of transmission properties for a sequence of scalable video to be transmitted over the wireless network, and for accessing the look-up table to obtain the optimal pair of Nₗᵢₘ,Eₜ corresponding to the set of determined transmission properties; and a system for transmitting the sequence of scalable video over the wireless network using the accessed optimal pair of Nₗᵢₘ,Eₜ.

The present invention further provides a program product stored on a recordable medium for providing power efficient transmission of scalable video over a wireless network, comprising: program code for determining a set of transmission properties for a sequence of scalable video to be transmitted over the wireless network; and program code for accessing a look-up table containing optimal pairs of Nₗᵢₘ,Eₜ for a plurality of different sets of transmission properties, wherein Nₗᵢₘ is a retry limit and Eₜ is a transmit energy per bit, to obtain the optimal pair of Nₗᵢₘ,Eₜ corresponding to the set of determined transmission properties, wherein the sequence of scalable video is transmitted over the wireless network using the accessed optimal pair of Nₗᵢₘ,Eₜ.

These and other features of this invention will be more readily understood from the following detailed description of the various aspects of the invention taken in conjunction with the accompanying drawings in which:

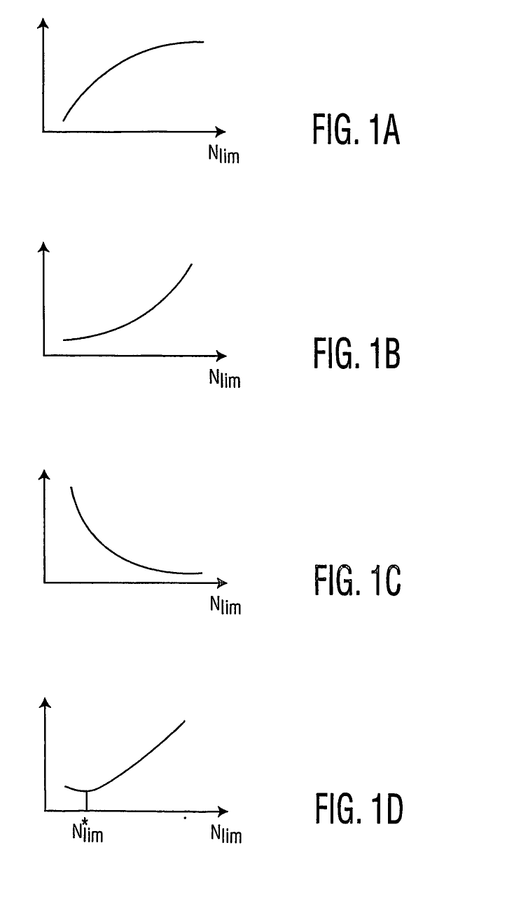

FIG. 1 illustrates the effect of the maximum retry limit Nₗᵢₘ on the overall transmission power.

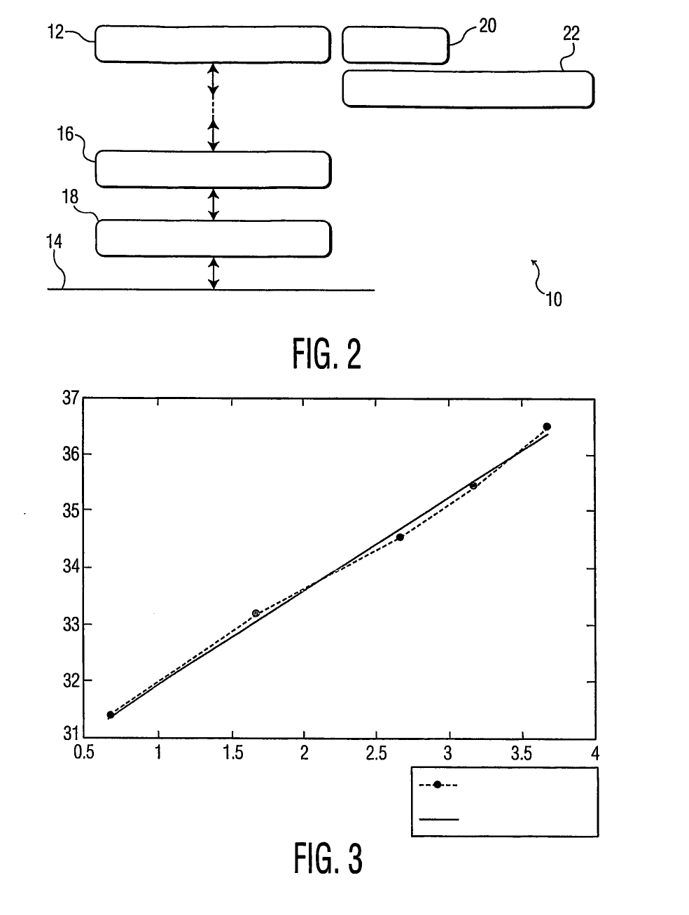

FIG. 2 illustrates a fine-granular-scalable video transmission system.

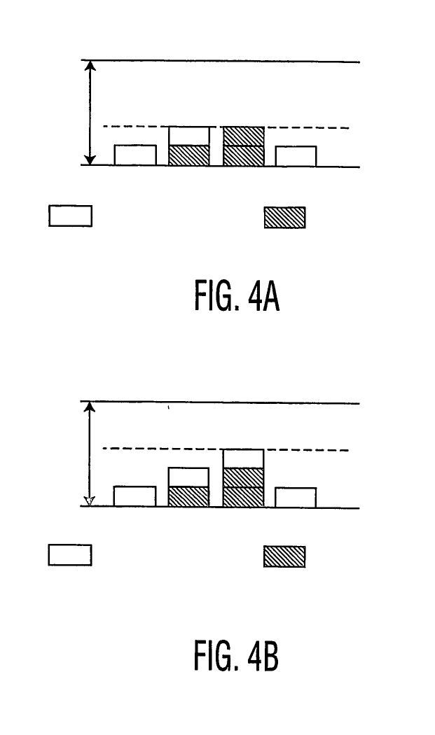

FIG. 3 illustrates PSNR for a sample video sequence.

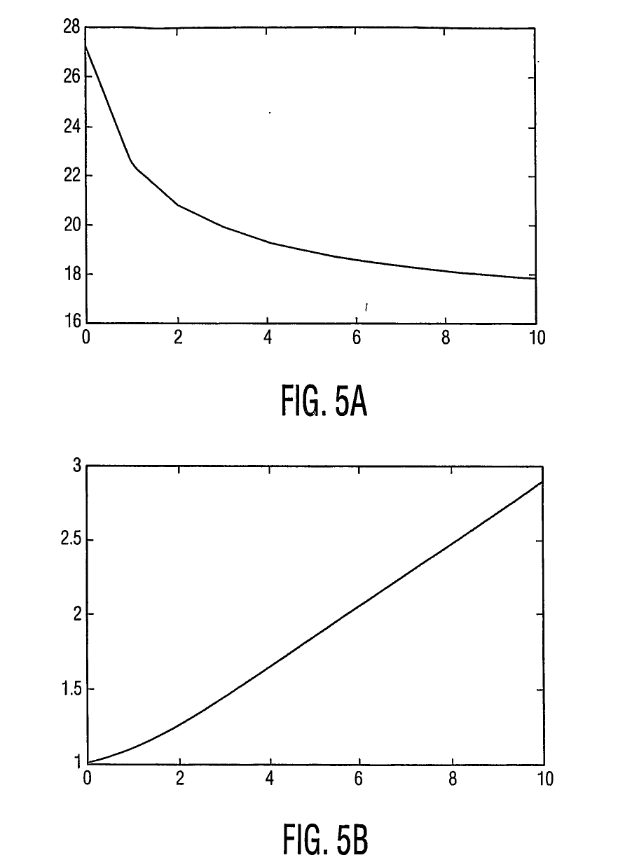

FIG. 4 illustrates transmission for different retry limits.

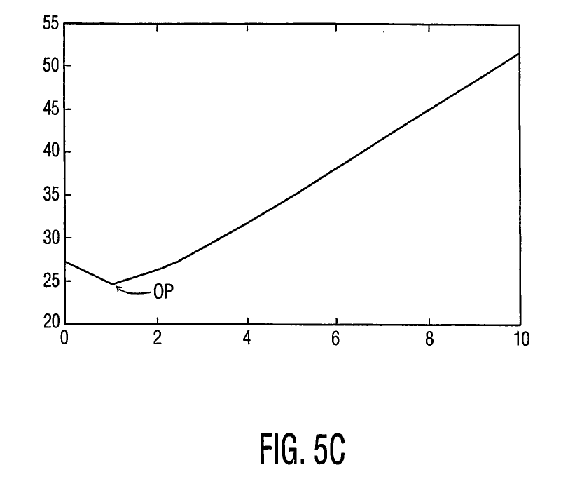

FIGS. 5A-5C illustrate, for a large p_{L}=1%, the required transmission energy per bit Eₜ required for a given PSNR; the average number of transmissions needed to transmit one packet successfully; and the transmission energy per bit to transmit one bit successfully, including retransmission.

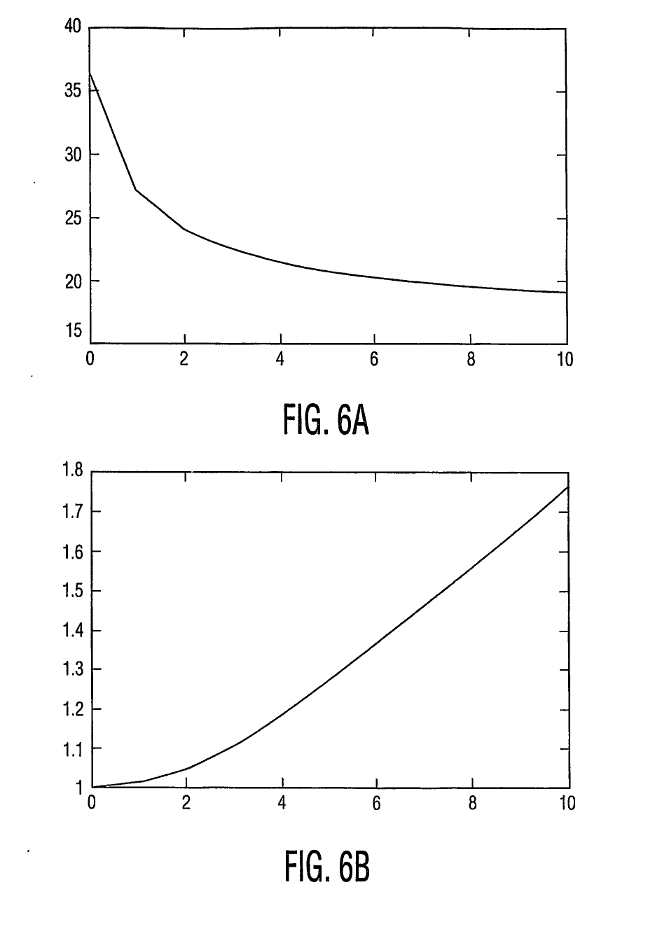

FIGS. 6A-6C illustrate, for a small p_{L}=0.01%, the required transmission energy per bit Eₜ required for a given PSNR; the average number of transmissions needed to transmit one packet successfully; and the transmission energy per bit to transmit one bit successfully, including retransmission.

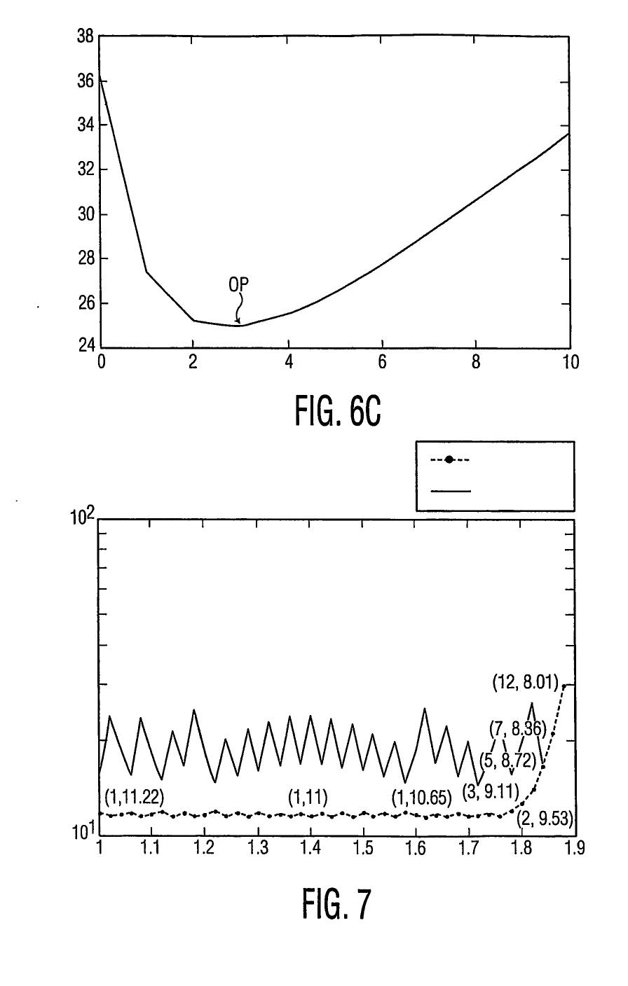

FIG. 7 illustrates power consumption versus distance.

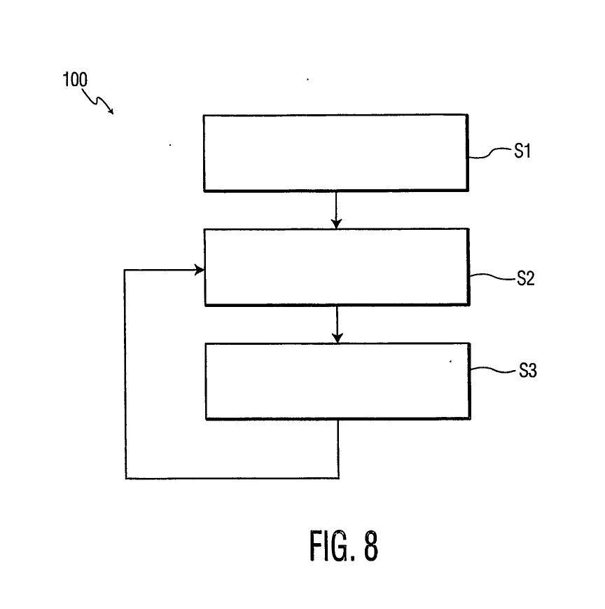

FIG. 8 illustrates a flowchart in accordance with an embodiment of the present invention.

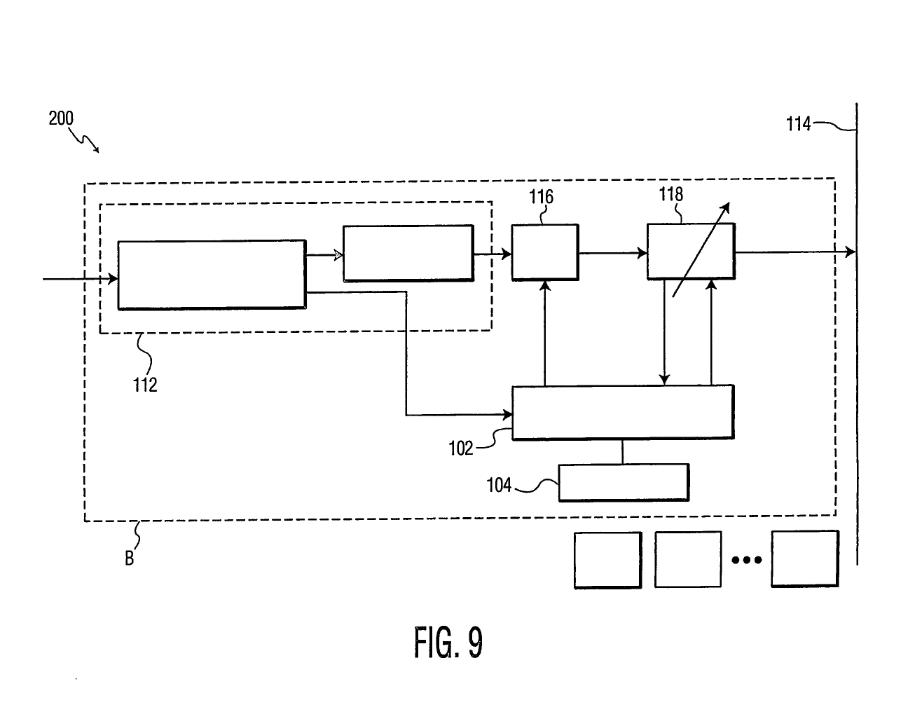

FIG. 9 illustrates a transmission system in accordance with an embodiment of the present invention.

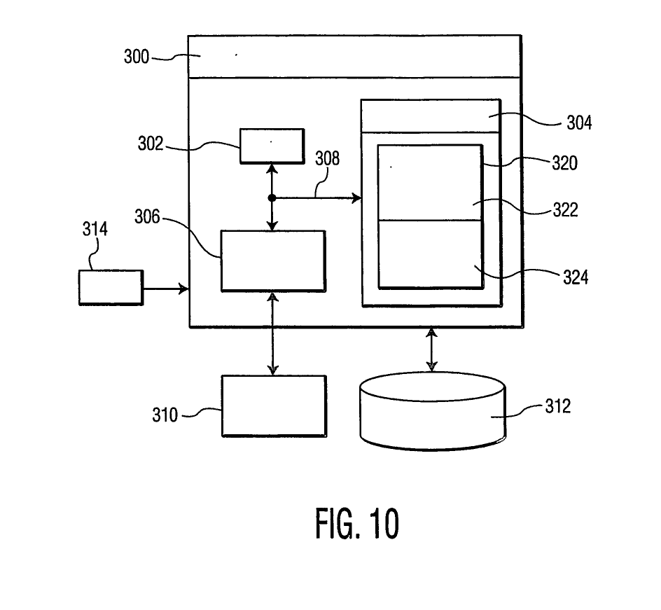

FIG. 10 illustrates a computer system for implementing the power manager of the present invention.

It should be noted that the drawings are merely schematic representations, not intended to portray specific parameters of the invention. The drawings are intended to depict only typical aspects of the invention, and therefore should not be considered as limiting the scope of the invention.

The present invention describes a method and system for reducing transmission power consumption for scalable video communication over a wireless network (e.g., a WLAN). This is achieved by choosing the maximum number of retransmission times based on the quality and delay requirement. Transmitter SNR is adjusted accordingly to maintain a constant end-to-end video quality. For different retry limits, hence different transmitter SNR's, we get different power consumptions. The present invention finds and uses the transmission power level to minimize the overall energy for power efficient scalable video transmission. Using the present invention, power efficient transmission of scalable video over a wireless LAN is achieved by adjusting the retransmission limit and the transmission power level given the underlying channel condition (SNR), which can be affected by noise, interference, and distance between the transmitter and the receiver.

Referring now to FIGS. 1(a)-(d), there is illustrated the effect of the maximum retry limit Nₗᵢₘ on the overall transmission power. As shown, as the retry limit increases, to keep the same end-to-end video quality, (1) the video stream can tolerate higher packet loss rate; (2) the transmit energy per bit is lower (3) the number of retransmission times increase or stay the same; (4) overall transmission power varies.

Generally, the larger the retry limit at the MAC layer is, the more retransmission numbers the transmitter can have. Hence, the number of transmissions, which includes both the first transmission and the following retransmission(s), is an increasing function of the retry limit Nₗᵢₘ as illustrated in FIG. 1(a). On the other hand, as the number of transmissions increases, the error control capability is enhanced, so that to keep a given quality at the receiver, the packet loss rate before any retransmission can be higher, i.e., the stream can tolerate more errors introduced by transmission. The relationship between the packet loss rate and retry limit is shown in FIG. 1(b). It is clear that the transmission energy per packet is a decreasing function of the packet loss rate. Thus, it is a decreasing function of retry limit Nₗᵢₘ as shown in FIG. 1(c). Integrating 1(a) and (c), the overall power as a function of the transmission energy and the number of transmission has an optimal point N*ₗᵢₘ (FIG. 1(d)) that minimizes the power consumption, hence prolonging battery life.

As an illustrative example, a Fine-Granular-Scalable (FGS) encoded video stream is to be transmitted. At the MAC layer, the retry limit can be adapted to the video quality requirement and the underlying channel conditions. At the physical layer, the energy to transmit a bit can be adjusted. In the following analysis, it is assumed that the bit stream is transmitted over an additive white Gaussian noise (AWGN) channel, and the theoretical effect of retry limit and transmission energy on the overall transmission power is analyzed. Then, a numerical analysis is presented for selecting the optimal operating point to minimize the overall power consumption.

Analytical Model

The system 10 considered in the present invention is illustrated in FIG. 2. In system 10, the video stream is compressed by a Fine-Granular-Scalable (FGS) encoder 12, modulated using differential phase-shift-keying, and transmitted over an underlying additive white Gaussian noise (AWGN) channel 14. The retry limit at the MAC layer 16, and the transmit energy at the physical layer 18, are adjusted to the video quality requirement and the underlying channel conditions. No channel encoder is used above the MAC layer.

The distortion caused by the FGS encoder 12 is first described. The parameters and the power consumption leading to a given distortion at the receiver by adjusting the MAC layer 16 and the physical layer 18 are discussed in the following section.

Distortion Model of the FGS Video Encoder

FGS encoding provides smooth quality degradation in order to adapt to changing network conditions. The FGS encoder 12 includes a base-layer encoder 20 and the enhancement layer encoder 22. The base layer is compressed by the base-layer encoder 20 using motion-compensation encoding method; the enhancement-layer encoder 22 is based on a fine-granular coding method. In this discussion, it is assumed that all base-layer bits are received without any error. The enhancement layer data is organized into packets and sent through the unreliable channel.

PSNR-rate Performance of the FGS Encoder

The FGS encoder 12 provides an almost linear relationship between the enhancement layer bit rate and the peak signal to noise ratio (PSNR), as shown in FIG. 3 for a sample video sequence. The linear function can be written as follows
PSNR=k_{FGS}Rₛ+c_{FGS} (1)

where Rₛ is the encoded source bit rate, and PSNR is the corresponding video PSNR. In FIG. 3, the parameters are derived by the least-mean-square-error method. For the sample video sequence, encoded at a frame rate of 30 fps and quantization stepsize of 10, the parameter values are listed in Table 1. From FIG. 3, it can be seen that there is a good match between the measurement data and the linear model.

TABLE 1
Simulation parameter settings

| Parameter Type | Parameter Value |
|---|---|
| Packetsize M (bytes) | 1000 |
| k_{FGS} (dB/Mbps) | 1.66 |
| c_{FGS} (dB) | 30.29 |
| R (Mbps) | 2.84 |
| R_{bl} (Mbps) | 0.67 |

Average PSNR at the Receiver at the Presence of Packet Loss

In the previous section, it was shown that the reconstructed video quality, measured in PSNR, is a linear function of encoded bit stream if no errors occur during transmission. The PSNR of the decoded video sequence when transmission error is introduced will now be presented, given a video sequence of a frame rate of fr fps, where each encoded frame consists of base layer data and Nₑₗ packets of enhancement layer data. It is assumed that when one packet error occurs, all following enhancement layer packets corresponding to the same video flame are discarded. When the first i packets are correctly received for one frame, the corresponding data rate at the receiver Rᵢ is
Rᵢ=fr×i×M+R_{bl} (2)
where M is the packet size, and R_{bl} is the data rate for the base layer. The parameter values used for numerical analysis in this disclosure are listed in Table 1. At the receiver, the video PSNR will be
PSNRᵢ=k_{FGS}Rᵢ+c_{FGS} (3)
The average PSNR at the receiver is

$$\begin{matrix}PSNR = {\sum }_{t = 0}^{{N}_{el}} {p}_{i} {PSNR}_{i} \\ = {\sum }_{i = 0}^{{N}_{el}} {p}_{i} ( {k}_{FGS} {R}_{i} + {c}_{FGS} ) \\ = {k}_{FGS} {\sum }_{i = 0}^{{N}_{el}} {p}_{i} {R}_{i} + {c}_{FGS}\end{matrix} \qquad ( 4 )$$

where pᵢ is the probability that the first i packets are received successfully.

Defining those data kept by the receiver as the effective data, and the amount of the effective data in one second as effective data rate Rₑₗ, which can be calculated as follows,

$$\begin{matrix}{R}_{el} = {\sum }_{i = 0}^{{N}_{el}} {p}_{i} {R}_{i} & ( 5 ) \\ we get & \\ PSNR = {k}_{FGS} {R}_{el} + {c}_{FGS} & ( 6 )\end{matrix}$$

Hence, as long as we can get a data rate of Rₑₗ, we expect the receiver can reach the corresponding PSNR on average.

If the residual packet loss rate after retransmission is p_{L},

$${p}_{i} = \{ \begin{matrix}{( 1 - {p}_{L} )}^{i} {p}_{L} , & for i = 0 , 1 , … , {N}_{el} - 1 \\ {( 1 - {p}_{L} )}^{{N}_{el}} , & for i = {N}_{el}\end{matrix} \qquad ( 7 )$$

Combining Eq. (2), (5) and (7), Rₑₗ can be written as following,

$$\begin{matrix}{R}_{el} = {\sum }_{i = 0}^{{N}_{el} - 1} [ {( 1 - {p}_{L} )}^{t} {p}_{L} i + {( 1 - {p}_{L} )}^{{N}_{el}} {N}_{el} ] Mfr + {R}_{bl} \\ = [ \frac{1 - {p}_{L}}{{p}_{L}} - \frac{{( 1 - {p}_{L} )}^{{N}^{el} + 1}}{{p}_{L}} ] Mfr + {R}_{bl}\end{matrix} \qquad ( 8 )$$

For a particular algorithm, in which Nₑₗ and M are fixed, Rₑₗ is determined by p_{L}. Thus, the average PSNR at the receiving side is decided by the residual packet error rate p_{L}. In the following section, it will shown how p_{L} is related to the retry limit at the MAC layer, transmit SNR at the physical layer, and power consumption.

Transmission Model

It will be shown how the retry limit Nₗᵢₘ and the transmit SNR at the physical layer control p_{L}, i.e., the PSNR at the receiver. The information bit stream is organized into packets, each containing M information bits. Packet error occurs when the receiver detects there is error within the received packet (even one single bit error can cause a packet error). The probability that a packet is erroneous, pₚ₀, depends on the received signal to noise ratio per bit. The physical layer will be discussed first, where the bit error rate is determined by the channel characteristics and the transmit energy Eₜ applied to each bit. Then, the manner by which the retransmission will reduce the error at the receiving side and how it introduces extra energy consumption by using multiple transmission for one video packet will be discussed.

Packet Error Rate pₚ₀

For simplicity, it is assumed that the channel is an AWGN channel, DPSK is used for modulation, and Eₜ is the transmit energy per bit. The received energy per bit E_{b} at the receiver is proportional to h, i.e., E_{b}=hEₜ, the path gain between two mobiles, which depends on the distance between them, where h is given by
h=cd^{-α} (9)
where c is a constant, and d is the distance between two stations. In this example, α=3.6. The value of c is chosen such that when two terminals are 100 m away, the received SNR per bit is from 2 dB to 16 dB. The bit error rate (BER) is

$${p}_{b} ( {E}_{b} ) = \frac{1}{2} {ⅇ}^{\frac{{E}_{b}}{{N}_{0}}} \qquad ( 10 )$$

where N₀ is noise power spectral density.

The packet error occurs when there is even one single bit error. For a packet of M bits, the packet error rate is

$${p}_{p 0} = 1 - ( 1 - {p}_{b} ( {E}_{b} ) ) M = 1 - ( 1 - \frac{1}{2} {ⅇ}^{\frac{{E}_{b}}{{N}_{0}}} ) \qquad ( 11 )$$

Residual Packet Loss Rate p_{L}

In wireless LAN, retransmission is used as the error control scheme. Only when all Nₗᵢₘ+1 transmissions are erroneous, will a packet not get through the channel successfully. Hence, the residual packet error rate, which is the probability that a packet is erroneous after Nₗᵢₘ+1 transmissions, is
p_{L}=pₚ₀^{N}_{^{lim}}⁺¹ (12)
As shown in FIG. 4, if the retry limit is higher, more packets may be transmitted correctly.
Average Transmission Times Nₜᵣ

As shown in FIG. 4, each video packet is transmitted until it is successfully transmitted or reaches the retry limit. The probability that a video packet is successfully sent at n^{th} try is pₚ₀ⁿ⁻¹(1−pₚ₀), while the probability that the transmission of a video packet reaches the retry limit without being successfully sent is pₚ₀^{N}_{^{lim}}⁺¹. Overall, the average number of transmissions for a video packet is

$${N}_{tr} ( {N}_{lim} ) = {\sum }_{n = 1}^{{N}_{lim} + 1} {np}_{p 0}^{n - 1} ( 1 - {p}_{p 0} ) + ( {N}_{lim} + 1 ) {p}_{p 0}^{{N}_{lim} + 1} \qquad ( 12 )$$

Overall Transmission Energy

From Eq. (12), it can be seen that for one video packet, either successfully transmitted or discarded due to limit on MAC layer retry, the average energy used is
Eₚ(Eₜ,Nₗᵢₘ)=Eₜ×Nₜᵣ(Nₗᵢₘ)×M (13)

For a video sequence of a frame rate of fr fps, and for each frame containing Nₑₗ packets in the enhancement layer, the power consumption by the enhancement layer data is
Pₐₗₗ(Eₜ,Nₗᵢₘ)=Eₜ×Nₜᵣ(Nₗᵢₘ)×M×Nₑₗ×fr (14)
The optimization problem of the present invention can therefore be formulated as
Min Pₐₗₗ subject to delay and bandwidth constraint.

In this example it is assumed that there is a sufficiently high bandwidth. If the upper bound of the retry limit is set to satisfy the delay constraint, the optimization problem can be specified as
Min Pₐₗₗ(Eₜ,Nₗᵢₘ)=Eₜ×Nₜᵣ(Nₗᵢₘ)×M×Nₑₗ×fr
Subject to Nₗᵢₘ<Nᵤₚₚₑᵣ.
Numerical Results

In this section, the performance of the method of the present invention is examined. First, the performance under different quality requirements when the distance between the transmitter and the receiver is fixed is considered. Then, the case where the quality requirement is the same, but the receiver is moving around, is considered. The parameter values used in the simulation are summarized in Table 1. Here the sample video sequence is encoded at a frame rate of 30 fps, and the transmitted data rate is 2.84 Mbps, corresponding to a PSNR of 35 dB if no error occurs. The base layer data rate is 0.67 Mbps and the PSNR reconstructed from the base layer is 30.29 dB. The enhancement layer data is packetized into 9 packets, each containing 1000 bytes. At the physical layer, the received signal to noise ratio is chosen from 2 dB to 16 dB when two mobiles are 10 m away. The maximum retry limit is set at Nᵤₚₚₑᵣ=20 so as to guarantee one packet can be received within the delay constraint.

For the figures (i.e., FIGS. 5A-C, 6A-C) demonstrating the performance, the power consumption is normalized by a scaling factor

$${c}_{sf} = \frac{1}{c} {d}_{0}^{α} {N}_{0} {MN}_{el} fr \qquad ( 18 )$$

i.e., the values shown in the figures are

$${P}_{sf} = \frac{{E}_{b}}{{N}_{0}} {( \frac{ⅆ}{{ⅆ}_{0}} )}^{α} {N}_{tr} \qquad ( 19 )$$

Minimize for Different Requirement of PSNRs

In this section, the manner by which the optimal points vary with the requirement of PSNR when the distance is fixed at d=10 m is analyzed. Different PSNR requirements at the receiving side will be considered. Two different p_{L} are used to simulate different quality requirements. The results are presented in FIGS. 5A-C and 6A-C.

The transmission energy per bit Eₜ for a given PSNR, the average number of transmissions needed to transmit one packet successfully, and the transmission energy per bit to transmit one bit successfully, including retransmission, as described in Eq. (14), (15) and (17) for a given video quality corresponding to p_{L}=1%, are illustrated in FIGS. 5A-C, respectively. As shown in FIG. 5A, as the retry limit increases, the same video quality can be obtained by a lower energy per bit Eₜ. Also, as shown in FIG. 5B, as the retry limit increases, there may be more retransmissions deployed in the presence of severe channel impairment.

Combining FIGS. 5A and 5B, the power consumption is shown in FIG. 5C. The power consumption is scaled by c_{sf} as in Eq. (18). The optimal point OP here occurs at Nₗᵢₘ=1, i.e., increasing transmission energy per bit Eₜ is always more efficient than transmitting more times for high p_{L}. Comparing the power consumption at the optimal point with the power consumption at Nₗᵢₘ=10, a power saving of around 50% can be gained.

In FIGS. 6A-C, the scenario for p_{L}=0.01%, representing a higher receiving video quality for the same channel condition in FIGS. 5A-C, is illustrated. Comparing FIGS. 6A-C with FIGS. 5A-C, it can be seen that for higher quality, a greater retry limit to gain high error correction capability is needed. In particular, as shown in FIG. 6C, for p_{L}=0.01%, the optimal point occurs with retransmission limit N*ₗᵢₘ=3.

Minimize the Power Consumption Over a Range of Distance

In this section, the scenario when the receiving terminal moves around is analyzed (e.g., a distance from 10 m to 20 m, simulating a home environment). For each distance, the optimal pair of (Nₗᵢₘ,Eₜ) is calculated. The results are summarized in FIG. 7. Note here that Eₜ is normalized with respect to

$$\frac{c}{{d}_{0}^{α} {N}_{0}} ,$$

where d₀=10 m. It has been found that when the distance goes large, high retry limits are preferred. The power consumption for Nₗᵢₘ=10 is also shown in FIG. 7. Comparing the two curves, the algorithm of the present invention outperforms the scheme in which Nₗᵢₘ is set to a large value. If Nₗᵢₘ is set to a small value, for instance, Nₗᵢₘ=1, it repeats the optimal curve for the small distance up to d=16 m in this simulation, but it is unable to adapt to the large distance, i.e., the quality can not be kept at the desired level. There is a fluctuation for the Nₗᵢₘ=10 scheme and some inconsistency for optimal curve. This is due to the fact that for discrete sets of Nₗᵢₘ and Eₜ, the resulted PSNR is in fact not a constant, but always higher than the expected value.
Implementation

The 802.11 MAC/PHY standard allows devices to alter the transmission energy level and retry limit on the fly. Both increasing retry limits Nₗᵢₘ at the MAC layer and the transmission energy level Eₜ at the physical layer (PHY) provide higher error protection for the data transmitted. However, to reach the same video quality at the receiver, they act differently in the sense of power consumption. The present invention determines the optimal pair of (Nₗᵢₘ,Eₜ) that minimizes the power consumption.

A flowchart 100 and system diagram 200 illustrating an implementation of the present invention are provided in FIGS. 8 and 9, respectively. This implementation provides a “power manager 102,” whose operations may be distributed between a base station B and one or more portable terminals TER over a wireless network.

In step S1, the adaptation rules for a discrete set of quality requirements, channel 114 conditions, and video sequence properties (e.g., the relationship between PSNR and the rate for FGS encoder 112) are pre-computed and stored as a look-up table 104 in the base station B. An optimal operating pair of (Nₗᵢₘ,Eₜ) is provided in the look-up table 104 for each set of data.

In step S2, during communication of a scalable video sequence, the QoS requirements, channel conditions, and video sequence properties are detected and are reported to the power manager 102. Based on this criterion, the power manager 102 determines the optimal operating pair of (Nₗᵢₘ,Eₜ) by accessing the pre-computed look-up table 104. The Nₗᵢₘ from the optimal operating pair is provided to the MAC layer 116, while the Eₜ from the optimal operating pair is provided to the PHY layer 118. In step S3, these operating points are updated frequently (e.g., after time T) in order to follow the time-varying, application specific characteristics of the wireless channel 114.

It should be understood that the present invention can be realized in hardware, software, or a combination of hardware and software. Any kind of computer/server system(s)—or other apparatus adapted for carrying out the methods described herein—is suitable for the practice of the present invention. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

An example of a computer system 300 is shown in FIG. 10. The computer system 300 generally comprises a central processing unit (CPU) 302, memory 304, input/output (I/O) interfaces 306, bus 308, external devices 310 and database 312. A user 314 may interact with the computer system 300 (e.g., to generate look-up table 104 (FIG. 9)).

Computer 300 can comprise any general purpose or specific-use system utilizing standard operating system software, which is designed to drive the operation of the particular hardware and which is compatible with other system components and I/O controllers. The CPU 302 may comprise a single processing unit, multiple processing units capable of parallel operation, or can be distributed across one or more processing units in one or more locations, e.g., on a client and server. The memory 304 may comprise any known type of data storage and/or transmission media, including magnetic media, optical media, random access memory (RA), etc. Moreover, similar to the CPU 302, the memory 304 may reside at a single physical location, comprising one or more types of data storage, or be distributed across a plurality of physical systems in various forms.

The I/O interfaces 306 may comprise any known system for exchanging information with one or more external devices 310. The external devices 310 may comprise any known type of input/output device capable of communicating with I/O interfaces 306 with or without additional devices. The bus 308 provides a communication link between each of the components in computer 300 and likewise may comprise any known type of transmission link, including electrical, optical, wireless, etc. Other known components may also be incorporated into the computer 300.

The database 312 may provide storage for information necessary to carry out the present invention. For example, the look-up table 104 (FIG. 9) may be stored within the database 312. The database 312 may include one or more storage devices, such as a magnetic disk drive or an optical disk drive. Further, the database 312 can include data distributed across a network such as LAN, WAN, or the Internet.

A power manager 320 in accordance with the present invention is shown stored in memory 304 as computer program code. The power manager 320 includes a information system 322 for determining/receiving “transmission properties” such as QoS requirements, channel conditions, video sequence properties, etc., and an optimizing system 324 for determining the optimal operating pair of (Nₗᵢₘ,Eₜ) for each time T by accessing the pre-computed look-up table stored in the database 312. Nₗᵢₘ and Eₜ are subsequently provided to the MAC and PYS layers 116, 118 (FIG. 9) via the I/O interfaces 306.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method for power efficient transmission of scalable video over a wireless network, comprising:
creating a look-up table containing optimal pairs of Nₗᵢₘ,Eₜ for a plurality of different sets of transmission properties, wherein Nₗᵢₘ is a retry limit and Eₜ is a transmit energy per bit;
determining a set of transmission properties for a sequence of scalable video to be transmitted over the wireless network;
accessing the look-up table to obtain the optimal pair of Nₗᵢₘ,Eₜ corresponding to the set of determined transmission properties; and
transmitting the sequence of scalable video over the wireless network using the accessed optimal pair of Nₗᵢₘ,Eₜ.

2. The method of claim 1, wherein each set of transmission properties includes at least one of quality-of-service requirements, channel conditions, and video sequence properties.

3. The method of claim 1, further including:
encoding the sequence of scalable video using a Fine-Granular-Scalable encoder.

4. The method of claim 1, wherein the sequence of scalable video is encoded using a base layer encoder and an enhancement layer encoder.

5. The method of claim 1, further comprising:
providing Nₗᵢₘ to a medium access control (MAC) layer of the wireless network; and
providing Eₜ to a physical layer of the wireless network.

6. The method of claim 1, further comprising:
repeating the determining, accessing, and transmitting steps to follow time varying characteristics of the wireless network.

7. A system for power efficient transmission of scalable video over a wireless network, comprising:
a look-up table containing optimal pairs of Nₗᵢₘ,Eₜ for a plurality of different sets of transmission properties, wherein Nₗᵢₘ is a retry limit and Eₜ is a transmit energy per bit;
a system for determining a set of transmission properties for a sequence of scalable video to be transmitted over the wireless network, and for accessing the look-up table to obtain the optimal pair of Nₗᵢₘ,Eₜ corresponding to the set of determined transmission properties; and
a system for transmitting the sequence of scalable video over the wireless network using the accessed optimal pair of Nₗᵢₘ,Eₜ.

8. The system of claim 7, wherein each set of transmission properties includes at least one of quality-of-service requirements, channel conditions, and video sequence properties.

9. The system of claim 7, further including:
a Fine-Granular-Scalable encoder for encoding the sequence of scalable video.

10. The system of claim 7, further including a base layer encoder and an enhancement layer encoder for encoding the sequence of scalable video.

11. The system of claim 7, wherein the wireless network includes a medium access control (MAC) layer and a physical layer, and wherein Nₗᵢₘ is provided to the MAC layer of the wireless network and Eₜ is provided to the physical layer of the wireless network.

12. The system of claim 7, wherein the determining system updates the set of transmission properties after a predetermined interval, and accesses the look-up table to obtain an updated optimal pair of Nₗᵢₘ,Eₜ corresponding to the updated set of determined transmission properties, and wherein the transmitting system transmits the sequence of scalable video over the wireless network using the updated optimal pair of Nₗᵢₘ,Eₜ.

13. A program product stored on a recordable medium for providing power efficient transmission of scalable video over a wireless network, comprising:
program code for determining a set of transmission properties for a sequence of scalable video to be transmitted over the wireless network; and
program code for accessing a look-up table containing optimal pairs of Nₗᵢₘ,Eₜ for a plurality of different sets of transmission properties, wherein Nₗᵢₘ is a retry limit and Eₜ is a transmit energy per bit, to obtain the optimal pair of Nₗᵢₘ,Eₜ corresponding to the set of determined transmission properties, wherein the sequence of scalable video is transmitted over the wireless network using the accessed optimal pair of Nₗᵢₘ,Eₜ.

14. The program product of claim 13, wherein each set of transmission properties includes at least one of quality-of-service requirements, channel conditions, and video sequence properties.

15. The program product of claim 13, wherein the sequence of scalable video is encoded using a Fine-Granular-Scalable encoder.

16. The program product of claim 13, wherein the sequence of scalable video is encoded using a base layer encoder and an enhancement layer encoder.

17. The program product of claim 13, further comprising:
program code for providing Nₗᵢₘ, to a medium access control (WAC) layer of the wireless network, and
program code for providing Eₜ to a physical layer of the wireless network.

18. The program product of claim 13, further comprising:
program code for updating the set of transmission properties after a predetermined interval, and for accessing the look-up table to obtain an updated optimal pair of Nₗᵢₘ,Eₜ corresponding to the updated set of determined transmission properties, and wherein the sequence of scalable video is transmitted over the wireless network using the updated optimal pair of Nₗᵢₘ,Eₜ.
